(19) United States
(12) Patent Application Publication
(10) Pub. No.: US 2007/0184285 A1
(43) Pub. Date: Aug. 9, 2007

(54) Light weight x-ray radiation shield for electronics components and related fabrication method

(76) Inventors: Dean Tran, Westminster, CA (US); Thomas Chung, Redondo Beach, CA (US); Alan Hirschberg, Thousand Oaks, CA (US); Luis Rochin, Temecula, CA (US); Mark Kintis, Manhattan Beach, CA (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/349,609

(22) Filed: Feb. 8, 2006

(51) Int. Cl. B32B 17/06; B32B 15/00

(52) U.S. Cl. 428/432

(57) ABSTRACT

Protection against x-ray radiation is provided by a thin layer of a zinc-based alloy. An electronics component housing and lid are made to include a base of a lightweight alloy, a thin coating of the zinc-based alloy and an exterior finish metal layer. The zinc-based alloy provides excellent radiation protection and other advantages, without a significant weight penalty.

### BACKGROUND OF THE INVENTION

This invention relates generally to manufacture of electronics components and, more particularly, to techniques for protecting electronics components from the harmful effects of x-ray radiation. Most electronics packages used in space applications are expected to be exposed to high doses of “hard” x-ray radiation (typically defined as x-rays at energy levels above 10 keV). Attempts to shield components from such radiation have required the use of shields of Kovar (an alloy of iron, nickel and cobalt), tantalum, or aluminum (either pure or alloyed with other metals). Tantalum (Ta), for example, provides adequate x-ray shielding but is a very heavy metal (density=16.7 g/cc). Aluminum (Al) is lighter than tantalum by a factor of about six, but does not provide adequate x-ray shielding. Similarly, Kovar also provides adequate x-ray shielding but is too heavy for most space applications. Therefore, there is still a need to protect electronics components from ionizing processes caused by x-ray radiation exposure, but preferably without incurring the weight and cost detriment of shields made from heavy metals, such as Kovar or tantalum. Ideally, x-ray radiation protection should be provided directly during manufacturing, rather than added as an additional shielding component. The present invention achieves these goals, as will become apparent from the following summary.

### SUMMARY OF THE INVENTION

The present invention resides in a light-weight x-ray radiation shield for electronics components, comprising an electronics enclosure having at least one layer of a zinc alloy. The zinc alloy provides excellent radiation protection without adding significantly to the weight of the enclosure.

In one embodiment of the invention, the electronics enclosure is a cast zinc alloy enclosure, typically comprising a housing and a lid. In another disclosed embodiment, each of the housing and the lid comprises a light-weight alloy body, a thin film of a zinc alloy formed over the body and a finish metal layer formed over the thin film of zinc alloy.

In the disclosed embodiment, the light-weight alloy body is of an aluminum alloy. the zinc alloy is of zinc and aluminum and the finish metal layer is of nickel and gold. The zinc alloy film may be on the order of 100 microns thick. In accordance with another aspect of the invention the electronics enclosure further comprises an interior layer of Ti/Pd/Ag (titanium/palladium/silver) to function as a hydrogen and moisture gatherer.

In method terms, the invention may be defined as a method for manufacturing an electronics enclosure with an integral light-weight x-ray radiation shield. Briefly, and in general terms, the method comprises forming a housing that comprises at least one layer of a zinc alloy for radiation protection; and forming a housing lid that also comprises at least one layer of a zinc alloy for radiation protection.

More specifically, each of the forming steps comprises forming a body of a lightweight alloy; forming a zinc alloy layer over the body; and forming a finish metal layer over the zinc alloy layer. Forming the body of the housing may include forming a cavity in the body, to enclose at least one electronics component. Moreover, the steps of forming the body of the housing and forming the body of housing lid, may include casting and machining steps.

Forming the zinc alloy layer may be effected by any of the steps of sputtering, electrochemically depositing, dipping or brushing. In accordance with another aspect of the invention, the method further comprises forming an interior enclosure layer of Ti/Pd/Ag (titanium/palladium/silver) on at least one of the housing and its lid, to function as a hydrogen and moisture gatherer.

It will be appreciated from the foregoing that the present invention represents a significant advance in the protection of electronics components from x-ray radiation in space. In particular, the invention makes use of a zinc alloy to provide radiation protection without adding significantly to the overall weight. Other aspects and advantages of the invention will become apparent from the following more detailed description, taken in conjunction with the accompanying drawings.

### BRIEF DESCRIPTION OF THE DRAWINGS

FIG. 1 is a cross-sectional view of an electronics package housing embodying the present invention.

FIG. 2 is a pair of graphs depicting the effect of a thin zinc shield on measured x-ray radiation.

FIG. 3 is a graph showing the percentage reduction of x-ray radiation afforded by a thin zinc filter.

### DETAILED DESCRIPTION OF THE INVENTION

As shown in the drawings for purposes of illustration, the present invention is concerned with techniques for shielding electronics components from x-ray radiation, as well as from magnetic fields. Prior to the present invention, adding heavy radiation shields of tantalum or other metals has proven to be costly in terms of either added weight or added cost. Use of aluminum as a shield is much lighter than Kovar or tantalum but is no nearly as effective as a radiation shield.

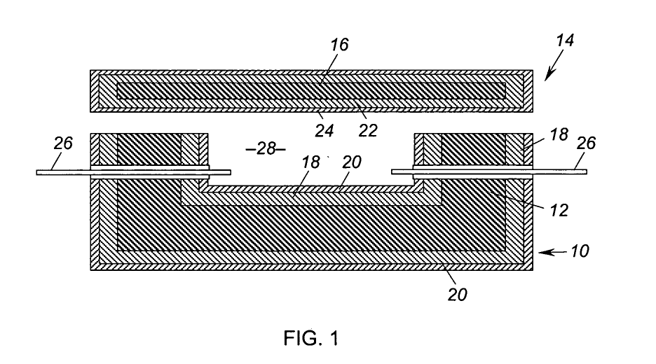

In accordance with the present invention, an alloy of zinc is used as the primary x-ray radiation shield for electronics components. A first preferred embodiment of the invention is shown in FIG. 1, in which a housing 10 for electronics components (not shown) is made principally from a light alloyed metal, such as an aluminum alloy, as indicated by reference numeral 12. Similarly, a lid 14 for the housing 10 is made principally from the same lightweight alloy, as indicated at 16. The lightweight alloy 12 in the housing 10 is coated with a thin film 18 (such as 100 microns or more thick) of zinc or a zinc alloy, except in peripheral regions that directly abut the lid 14. The coating technique may be electrochemical deposition, brushing, dipping or any other conventional technique. A finish metal layer 20, such as a nickel/gold alloy layer, is applied over the zinc-based layer 18. Preferably, the coating process and step of adding the finish metal layer 20 are followed by a diffusion step, in which zinc from the layer 18 is diffused into the underlying lightweight alloy housing material 12, and into the finish metal 20. This alloying of the zinc-based layer 18 avoids the possibility of formation of zinc whiskers, which is a well known problem with pure zinc and other pure metals. The lightweight alloy material 16 of the lid 12 is similarly coated with a zinc-based thin film 22 and a finish metal layer 24.

FIG. 1 also shows by way of example two feedthrough pins or leads 26 extending though the walls of the housing 10 into a cavity 28 formed by the assembled housing and lid 14 for external electrical connection.

In a presently preferred embodiment of the structure shown in FIG. 1, the lightweight alloy 12/16 is an aluminum alloy having a commercial designation A40, with a filler of 40% silicon and having a density of 2.74 g/cc. The zinc-based film 18/20 is preferably a zinc alloy designated ZA3, with 3% aluminum and a density of 6.6 g/cc, but other zinc alloys with at least 3% of a different metal would be suitable candidates. Pure zinc without nickel/gold or other alloy protective coating is not preferred because of its tendency to form whiskers over time. Because only a very thin film of the zinc alloy is needed, its density is of no great concern.

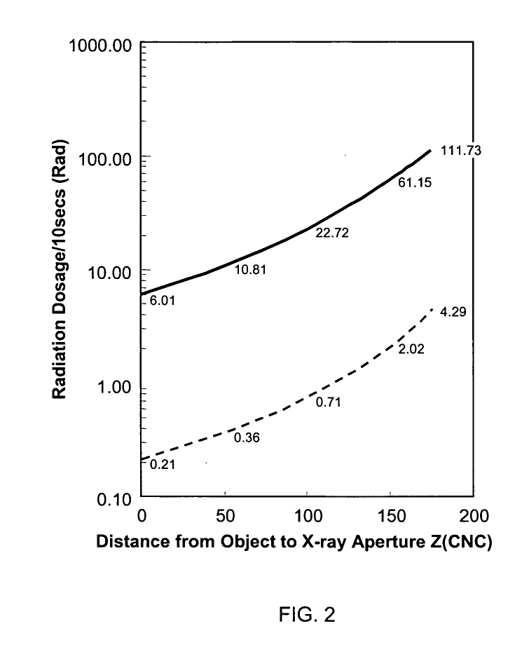

FIG. 2 graphically shows measurements of radiation made at various distances from an x-ray aperture. The upper curve represents the measurements without a filter in place. The lower curve represents the measurements made at various distances when a zinc foil shield of 200 microns (pm) is placed over the x-ray aperture. The vertical axis measures radiation dosage in rads for a 10-second exposure. The horizontal axis represents distance from the x-ray aperture on an arbitrary scale in which larger numbers represent greater proximity to the x-ray aperture. It will be observed that the radiation dosage scale is logarithmic and that the reduction in radiation afforded by interposing the zinc foil is greater than an order of magnitude.

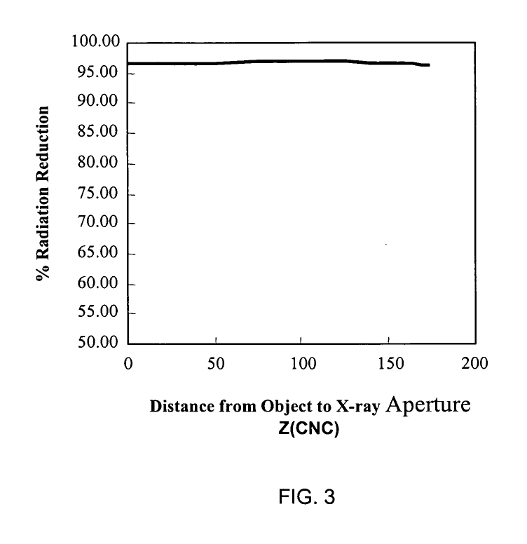

FIG. 3. plots the radiation-measurement data of FIG. 2 in a different way, where the vertical axis plots the percentage of radiation reduction afforded by the zinc foil filter. The reduction in radiation is approximately 96% without regard to distance from the x-ray aperture.

Although illustrated and described with reference to the FIG. 1 embodiment, the invention also encompasses an embodiment in which an entire electronics housing is molded or cast using an alloyed material with a low melting/freezing point, such as the zinc alloy ZA3. These zinc-based materials are better than Kovar because of their electrical and physical properties, namely their higher thermal and electrical conductivity, smaller coefficient of linear expansion, good electroplating characteristics, and lighter weight.

In accordance with another aspect of the invention, an electronics housing including zinc-based material for radiation protection may also include a thin film layer of Ti/PdAg deposited by sputtering of other means on the inside surface of the housing and lid. This final layer acts as hydrogen and moisture absorber to further protect highly sensitive devices within the housing.

It will be understood from this description that the present invention provides a number of important advantages over prior techniques for x-ray radiation protection of electronics components. Some of these advantages are: (a) lightness in weight; (b) faster removal of heat because of higher conductivity, (c) reduction in grounding resistivity because of higher conductivity, (d) improved ability to absorb hydrogen, (e) improved brazing capability for feedthrough of pins or leads, because brazing material is usually a zinc-based alloy, (f) lower manufacturing cost (if the casting embodiment is used), (g) lower assembly cost, since separate x-ray shields are not needed, (h) lower quality engineering costs because the zinc-based shielding absorbs hard x-rays but is still relatively transparent to soft x-rays used in non-destructive testing (inspection) of the electronics components.

It will be appreciated from the foregoing that the present invention represents a significant advance in the field of x-ray radiation protection for electronics components. Use of a thin layer of a zinc-based alloy in electronics component housing structures, or use of zinc-based materials to cast a complete electronics housing, both result in a structure that provides an effective x-ray radiation shield but also provides other desirable properties, such lightness in weight and good electrical and thermal conductivity. It will also be appreciated that, although specific embodiments of the invention have been illustrated and described, various modifications may be made without departing from the spirit and scope of the invention. Accordingly, the invention should not be limited except as by the appended claims.

1. A light-weight x-ray radiation shield for electronics components, comprising:
an electronics enclosure comprising at least one layer of a zinc alloy.

2. A light-weight x-ray radiation shield as defined in claim 1, wherein the electronics enclosure is a cast zinc alloy enclosure.

3. A light-weight x-ray radiation shield as defined in claim 1, wherein:
the electronics enclosure comprises a housing and a lid;
each of the housing and the lid comprises a light-weight alloy body, a thin film of a zinc alloy formed over the body and a finish metal layer formed over the thin film of zinc alloy.

4. A light-weight x-ray radiation shield as defined in claim 3, wherein:
the light-weight alloy body is of an aluminum alloy;
the zinc alloy is of zinc and aluminum; and
the finish metal layer comprises nickel and gold.

5. A light-weight x-ray radiation shield as defined in claim 4, wherein the thin film of zinc alloy is on the order of 100 microns thick.

6. A light-weight x-ray radiation shield as defined in claim 1, wherein the electronics enclosure further comprises an interior layer of Ti/Pd/Ag (titanium/palladium/silver) to function as a hydrogen and moisture gatherer.

7. A method for manufacturing an electronics enclosure with an integral light-weight x-ray radiation shield, the method comprising:
forming a housing that comprises at least one layer of a zinc alloy for radiation protection; and
forming a housing lid that also comprises at least one layer of a zinc alloy for radiation protection.

8. A method as defined in claim 7, wherein each of the forming steps comprises:
forming a body of a lightweight alloy;
forming a zinc alloy layer over the body; and
forming a finish metal layer over the zinc alloy layer.

9. A method as defined in claim 8, the step of forming a body of the housing also comprises forming a cavity in the body, to enclose electronics components.

10. A method as defined in claim 9, wherein each of the steps of forming the body of the housing and forming the body of housing lid comprises casting the bodies of the housing and the housing lid.

11. A method as defined in claim 9, wherein each of the steps of forming the body of the housing and forming the body of the housing lid comprises casting the body and then, in the case of the housing, forming the cavity.

12. A method as defined in claim 9, wherein the steps of forming the zinc alloy layer over the housing body and the housing lid body, comprise a step selected from the group consisting of sputtering, electrochemically depositing, dipping and brushing.

13. A method as defined in claim 7, and further comprising:
forming an interior layer of Ti/Pd/Ag (titanium/palladium/silver) on at least one of the housing and the housing lid, to function as a hydrogen and moisture gatherer.
